(19) United States
(12) Patent Application Publication
(10) Pub. No.: US 2008/0301041 A1
(43) Pub. Date: Dec. 4, 2008

(54) Method and system for processing financial transactions using multiple financial accounts

(76) Inventor: Mark Edward Bruk, Vancouver (CA)

Correspondence Address: KING & SPALDING LLP, 1180 PEACHTREE STREET, ATLANTA, GA, 30309-3521, US

(21) Appl. No.: 11/809,031

(22) Filed: May 31, 2007

(51) Int. Cl. G06Q 40/00

(52) U.S. Cl. 705/39

(57) ABSTRACT

Associating multiple existing financial accounts with a multi-card account. The single multi-card account may allow a cardholder to determine an order for processing a financial transaction among the multiple financial accounts. This ordering may be dependent on the type of financial transaction. Also, the cardholder may allows partial payments from multiple financial accounts, such that a single purchase could be allocated to multiple accounts associated with the multi-card account. These systems and methods minimize the number of cards a cardholder must carry, thus minimizing the chance of losing cards or otherwise having an unauthorized use of an account and also minimizing the chance of an embarrassing rejection of a transaction.

### FIELD OF THE INVENTION

This invention relates to a system and method for processing financial transactions. More particularly, this invention relates to processes and systems that allow multiple financial accounts to be represented by a single financial account and for processing financial transactions associated with the single financial account.

### BACKGROUND OF THE INVENTION

The use of financial cards for conducting financial transactions is ubiquitous. People use financial cards to purchase a variety of goods and services. Two principal types of financial cards are credit cards and debit cards. Typically, a credit card represents a line of credit that has been issued from a financial institution to an individual, the cardholder. The credit card allows the cardholder to purchase goods and services against the line of credit. The line of credit is associated with an account and that account has certain terms governing how credit is extended to the cardholder. Typical terms include an annual interest rate charged on the amount of money actually lent to the cardholder, a grace period that allows the cardholder to pay for purchases without incurring interest charges, annual fees for the account, and other fees, such a late payment fees. Credit cards may be issued by national card associations, such as AMERICAN EXPRESS or DISCOVER CARD; a financial institution in conjunction with a national card association, such as a Bank of America VISA or MASTERCARD; or directly from a retailer, such as MACY'S or BRITISH PETROLEUM. Commonly, a cardholder would have many different credit cards at one time.

In contrast, a debit card, sometimes referred to as a check card, allows the cardholder to withdraw funds from the cardholder's bank account. Instead of making a purchase on credit, as with a credit card, the purchase is made with funds that the cardholder actually has on hand. Generally, a debit card is issued from the financial institution that maintains the financial account containing the funds used for the purchases. This card may be the same card used to receive cash from automated teller machines (ATMs). In some cases, a national card association, such as VISA, may sponsor a debit card, such that the card is honored wherever a VISA credit card is honored. Even in this case, funds are still taken directly from the financial account, rather than against an established line of credit. Often, a cardholder would have both credit cards and debit cards.

Traditionally, these financial cards are plastic cards, 2.175 inches by 3.375 inches. The front of the card includes the cardholder's name, account number, expiration date, and logos associated with the card issuer. The back of the card typically would have a magnetic stripe, a “magstripe,” and a signature block. The magstripe is similar to a piece of cassette tape and has information about the account encoded on it. When a purchase is made, the magstripe is passed through a reader and the account information is captured.

Although plastic cards with magstripes are the most common type of cards, “smart cards” are becoming more prevalent. These cards include a computer microprocessor, or “chip,” that stores account information. Some of these cards work using radiofrequency identification (RFID) technology, where the account information is transmitted to a point-of-sale device without the card contacting the device. In some cases, this RFID technology allows the typical card to be replaced by another device, such as a key fob. An example of this type of financial card is Mobil Oil Company's SPEEDPASS, where a cardholder could wave the SPEEDPASS key fob in front of a detector on a Mobil gas pump to charge for the gasoline.

Standards have been established for credit card accounts from the national card associations. For example, card accounts that begin with the number “3” are for travel and entertainment cards, such as AMERICAN EXPRESS and DINER'S CLUB. Card accounts that begin with the number “4” are VISA accounts, with the number “5” are MASTERCARD accounts, and with the number “6” (indeed, “6011”) are DISCOVER CARD accounts.

Credit card and debit card purchase transactions follow the same general process. A cardholder makes a purchase from a merchant and presents a card to pay for the purchase. The information from the card is taken by the merchant and sent, along with information about the purchase and merchant, to a transaction processor. This transaction processor may be a card association, like American Express, or a third-party vendor, who provides a service to financial institutions by authorizing financial card transactions. For a credit card purchase, the transaction processor compares the amount of the transaction with the amount of available credit on the account and either approves the purchase or declines the purchase. For example, a cardholder may have a VISA card account from BANK OF AMERICA with a $2500 credit limit. In other words, BANK OF AMERICA has extended the cardholder $2500 worth of credit. The cardholder may have only $1000 of available credit on the account. This situation occurs when the cardholder has made $1500 worth of other purchases that have yet to be paid. If the cardholder tries to purchase a $1200 television set, that transaction would be declined, since the cardholder has only $1000 of available credit. Conversely, if the cardholder tries to purchase a meal for $50, that transaction would be approved.

For transactions that are approved, the available credit limit is reduced by the amount of the purchase. The transaction processor reconciles accounts to keep the available credit value up-to-date.

For debit cards, the process is comparable, except the transaction is checked against available funds in an account. At the end of the day, funds are transferred from the account associated with the debit card to the merchant. Often, debit card transactions require a cardholder to enter a personal identification number (PIN) to complete the transaction. A PIN provides an added layer of security, preventing an unauthorized user from accessing the financial account. Of course, some credit cards may also require a PIN in the transaction process.

When the transaction information is sent to the transaction processor, a merchant ID number is included. This ID is unique to a merchant. This ID may have a merchant category code (MCC) associated with the merchant ID. The MCC represents the type of transactions that the merchant makes. For example, the MCC 5462 is for a bakery and the MCC 7216 is for a dry cleaner. These MCCs are grouped into merchant category code groups (MCCGs), such as MCCG1 for airlines and MCCG4 for restaurants. By associating a merchant ID with an MCC or MCCG, the category of purchase being made can be determined. Of course, the MCC represents a main type of transaction for the merchant. A merchant may provide goods and services covering multiple MCCs and MCCGs. That merchant would be associated with a single MCC and MCCG only.

A merchant may have a point-of-sale device at a store where the cardholder makes a purchase. The cardholder may present a financial card to the merchant and the merchant swipe the magstripe using the point-of-sale device. Alternatively, a cardholder may go through a self-service checkout line where the cardholder swipes the card and completes the transaction. In some cases, a merchant may get a voice authorization for a purchase. In this case, the card is not swiped, but instead, the merchant calls a number and provides information, either orally or by using a touch-tone phone and then receives an authorization. In other cases, the merchant may have a virtual terminal. A computer running software captures the information about the purchase and cardholder's account and sends the authorization request over the Internet to a transaction processor.

The above process envisions that the cardholder presents the card to the merchant (a “card present” transaction). In some cases, a purchase is made remote from the merchant (a “card not present” transaction). This type of transaction may be conducted over the phone or over the Internet. For these purchases, the card information cannot be directly captured. For example, a cardholder may make a purchase from an on-line retailer, such as AMAZON.COM, The cardholder would provide information about the credit account (account number, type, expiration date, and possibly a security code number). Often, merchants that allow for purchases where the card is not present are charged higher fees to process a transaction, given the higher risk of fraud. A merchant that enables both purchases over the Internet and at a brick-and-mortar store would likely have two merchant ID numbers.

The prevalence of credit card and debit card transactions has lead to individuals having a large number of financial card accounts. One problem with this proliferation of cards is that, if a cardholder loses her wallet, then the loss typically must be reported to a large number of card issuers and a large number of cards have to be replaced. The cardholder is often also at risk for a certain amount of charges on a lost card, such as the first $50 charged. With multiple cards, this charge may be incurred for each lost card.

Another issue with a credit or debit card is that the card is linked to a single credit line or account. Should a purchase exceed the available credit limit or available funds in an account, the cardholder is subjected to the embarrassment of a rejected or declined transaction. The cardholder may have to have the merchant go through a few accounts before one is found that has sufficient funds or available credit limit to satisfy the transaction.

What is needed is a single financial card that can be linked to multiple credit and debit accounts. This single account would reduce the security risk associated with carrying multiple cards around. The single financial card would be able to access multiple accounts for a single purchase. In this way, varying amounts of available funds or available credit lines associated with these multiple accounts would be available to a cardholder for a single purchase, reducing the likelihood of an embarrassing rejection of the purchase.

### SUMMARY OF THE INVENTION

The present invention provides systems and methods for associating multiple financial accounts with a single multi-card account. The single multi-card account may allow a cardholder to determine an order for processing a financial transaction among the multiple financial accounts. This ordering, or ranking, may be dependent on the type of financial transaction. Also, the cardholder may allows partial payments from multiple financial accounts, such that a single purchase could be allocated to multiple accounts associated with the multi-card account. These systems and methods minimize the number of cards a cardholder must carry, thus minimizing the chance of losing cards or otherwise having an unauthorized use of an account and also minimizing the chance of an embarrassing rejection of a transaction.

In one aspect of the present invention, a method for processing a financial transaction is provided. The method includes the steps of: (1) associating a multi-card account with a plurality of existing financial accounts; (2) receiving from the multi-card account cardholder a ranking for the existing financial accounts, where the ranking includes the preferred order for which the existing financial accounts should be accessed to fund the financial transaction; (3) receiving an authorization request for the financial transaction for the multi-card account includes an amount of money representing the outstanding balance for the financial transaction; and (4) determining the existing financial account to pay the outstanding balance for the financial transaction based on the received ranking.

In another aspect of the present invention, a method for processing a financial transaction is provided. This method includes the steps of: a) receiving an authorization request for the financial transaction for the multi-card account including an amount of money representing the outstanding balance for the financial transaction, where the multi-card account comprises a plurality of existing financial accounts; b) determining a existing financial account to pay the outstanding balance for the financial transaction based on a received ranking, where the ranking includes the preferred order for which the existing financial accounts should be accessed to fund the financial transaction; c) selecting a first existing financial account comprising the first ranked existing financial account; d) determining the amount of available funds or available credit limit associated with the selected existing financial account; e) charging the selected existing account an amount of money comprising the lesser of the amount of available funds or available credit limit for the selected existing account and the outstanding balance for the financial transaction; f) calculating the difference between outstanding balance for the financial transaction and the amount of money charged the selected account at step c), where this difference is the updated outstanding balance for the financial transaction; g) if the updated outstanding balance is greater than zero, selecting the next lower ranked existing financial account; h) repeating steps d) through g) as necessary until the updated outstanding balance for the financial transaction equals zero; and i) approving the authorization request.

In yet another aspect of the present invention, a system for processing a financial transaction is provided. This system includes: a managing module, operable to receive a ranking of a plurality of existing financial accounts comprising a multi-card account, wherein the ranking is the preferred order for which the existing financial accounts should be accessed to fund the financial transaction; and a transaction processing module, operable to process an authorization request for a financial transaction associated with a multi-card account, where the processing is based on the ranking of the plurality of existing financial accounts.

In still another aspect of the present invention, a multi-card for purchasing goods or services is provided. The multi-card includes a plurality of existing financial accounts where the plurality of financial accounts comprise a ranking indicating the preferred order for which the existing financial accounts should be accessed to fund the financial transaction.

### BRIEF DESCRIPTION OF THE DRAWINGS

FIG. 1 depicts an operating environment in accordance with an exemplary embodiment of the present invention.

FIG. 2 depicts a software architecture in accordance with an exemplary embodiment of the present invention.

FIG. 3 depicts an overall process flow in accordance with an exemplary embodiment of the present invention.

FIG. 4 depicts a process flow for associating existing financial accounts with a multi-card account in accordance with an exemplary embodiment of the present invention.

FIG. 5 depicts a process flow for managing a multi-card account in accordance with an exemplary embodiment of the present invention.

FIG. 6 depicts the process flow for a transaction authorization in accordance with an exemplary embodiment of the present invention.

FIG. 7 depicts a process flow for identifying an account to satisfy the authorization request in accordance with an exemplary embodiment of the present invention.

FIG. 8 depicts a process flow for identifying a subsequent account to satisfy the authorization request in accordance with an exemplary embodiment of the present invention.

### DETAILED DESCRIPTION OF THE EXEMPLARY EMBODIMENTS

Exemplary embodiments of the present invention are provided. These embodiments provide systems and methods for representing multiple existing financial accounts with a single financial card account (hereinafter referred to as a “multi-card account”). The single multi-card account may allow a cardholder to determine an order for processing a financial transaction among the multiple financial accounts. This ordering, or ranking, may be dependent on the type of financial transaction. Also, the cardholder may allows partial payments from multiple financial accounts, such that a single purchase could be allocated to multiple accounts associated with the multi-card account. These systems and methods minimize the number of cards a cardholder must carry, thus minimizing the chance of losing cards or otherwise having an unauthorized use of an account and also minimizing the chance of an embarrassing rejection of a transaction.

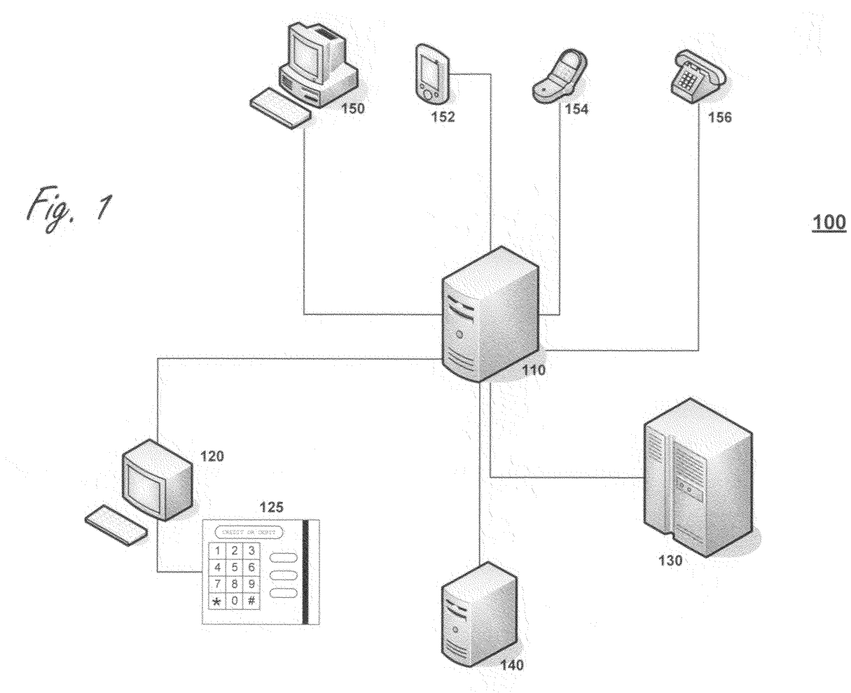

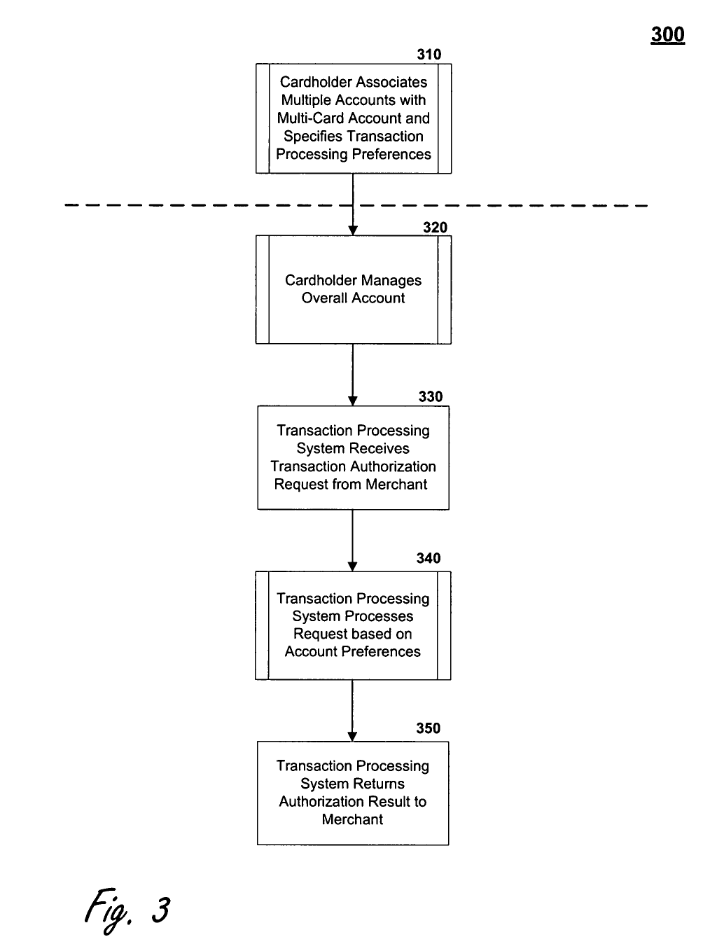

FIG. 1 depicts an operating environment 100 in accordance with an exemplary embodiment of the present invention. Referring to FIG. 1, a transaction processing system 110 supports the processing of transactions using a multi-card account associated with multiple financial accounts. The transaction processing system 110 allows a cardholder to access the system and manage the cardholder's multi-card account. The cardholder may access the financial account through a computer 150. The computer 150 may be linked directly to the transaction processing system 110, such as by a direct dial-up phone line, or through a public distributed network, such as the Internet. The cardholder may also access the transaction processing system 110 though a personal digital assistant (PDA) 152, mobile phone 154, or land-line telephone 156. The cardholder may access the transaction processing system 110 to view the status of her multi-card account, add or remove credit or debit accounts from the multi-card account, pay account balances, and set preferences for the multi-card account. These preferences would include a ranking, or order, in which existing financial accounts are accessed when processing a transaction. Exemplary processes for a cardholder managing a multi-card account are discussed in greater detail below, in association with FIGS. 3, 4, and 5.

One of ordinary skill in the art would appreciate that a cardholder may contact the transaction processing system 110 and manage her multi-card account using any type of device capable of communicating with the transaction processing system 110 and the computer 150, the PDA 152, the mobile phone 154, or the land-line telephone 156 are but examples of such devices.

The transaction processing system 110 is also connected to merchant point-of-sale (POS) devices, such as merchant POS 120. The merchant POS 120 may include a terminal to capture card information, such as terminal 125. The merchant POS 120 transmits transaction details, account details, and a merchant ID to the transaction processing system 110. One of ordinary skill in the art would appreciate that the POS 110 could be a device that allows the magstripe card or smart card information to be captured, a virtual terminal, a web server (for a “card-not-present” transaction), a telephone where the merchant calls in the information to the transaction processing system 110, or other POS device.

The transaction processing system 110 is also attached to a card association or financial institution computer 130. This computer 130 either authorizes a transaction that is received by the transaction processing system 110 from the merchant POS 120 or supports an authorization by the transaction processing system 110.

Similarly, the transaction processing system 110 is also attached to a third-party vendor computer 140. This computer 140 may provide authorization services for a transaction that is received by the transaction processing system 110 from the merchant POS 120 or may support an authorization by the transaction processing system 110. Also, the third party vendor computer 140 may provide other services, such as card producing and issuing services. For example, the third party vendor computer 140 may support producing financial cards representing the multi-card account.

In one exemplary embodiment, the multi-card account would be a national account, such as a VISA or MASTERCARD account. The multi-card account would have a standard account numbering system, such as an account numbering system where all accounts started with the number “7.” Merchants would register with the transaction processing system 110 and would have a merchant ID unique to the multi-card account transaction processing system 110.

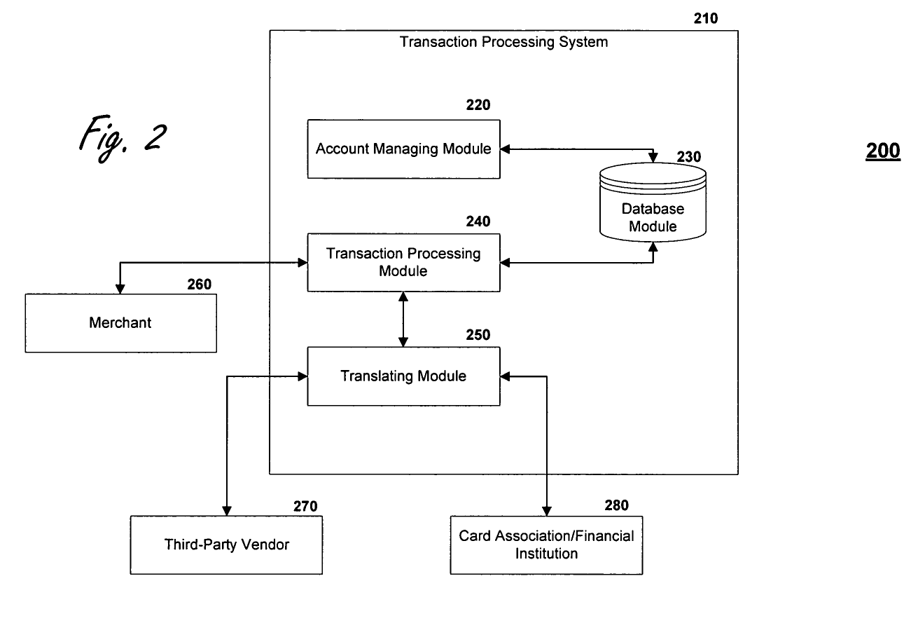

FIG. 2 depicts a software architecture 200 in accordance with an exemplary embodiment of the present invention. Referring to FIGS. 1 and 2, a transaction processing system 210 includes an account managing module 220, a transaction processing module 240, and a translating module 250. The account managing module 220 allows a cardholder to access and manage her multi-card account. The cardholder may use the account managing module 220 to associate multiple accounts with a multi-card account. The account managing module 220 may also allow the cardholder to establish a default ranking or order of accounts to be charged for given transactions. The account managing module 220 may also allow the cardholder to establish certain security parameters for the multi-card account, such as a PIN or password. The information supplied by the cardholder would be stored in a database module 230.

The transaction processing module 240 processes financial transactions for a multi-card account. A cardholder would make a purchase at a merchant, such as a merchant 260. The merchant 260 would process the purchase at a point-of-sale device, such as the merchant POS 120, including the terminal 125. The merchant POS 120 would capture multi-card information and the merchant 260 would transmit this information to the transaction processing module 240. The transaction processing module 240 processes the transaction sent from the merchant 260, based on cardholder preferences stored in the database module 230. The results of the processing would include either an approval or rejection of the purchase. FIGS. 3-8 below discuss transaction processing in greater detail.

The transaction processing module 240 may interact with a third-party vendor 270 or a card association/financial institution 280 when establishing a multi-card account or when approving a transaction. The third-party vendor 270 may provide card issuing services, where the third-party vendor 270 produces a card for a multi-card account. Also, the third-party vendor 270 may provide transaction processing services. Similarly, the card association/financial institution 280 may provide transaction processing services. Also, the card association/financial institution 280 may provide account details on individual accounts for a cardholder, where some of these accounts are included in the cardholder's multi-card account. For example, a cardholder's multi-card account may include a VISA card issued by BANK OF AMERICA. BANK OF AMERICA would be one possible card association/financial institution 280 and would provide details on the cardholder's VISA card account. The translation module 250 may be needed to interface with the third-party vendor 270 or the card association/financial institution 280

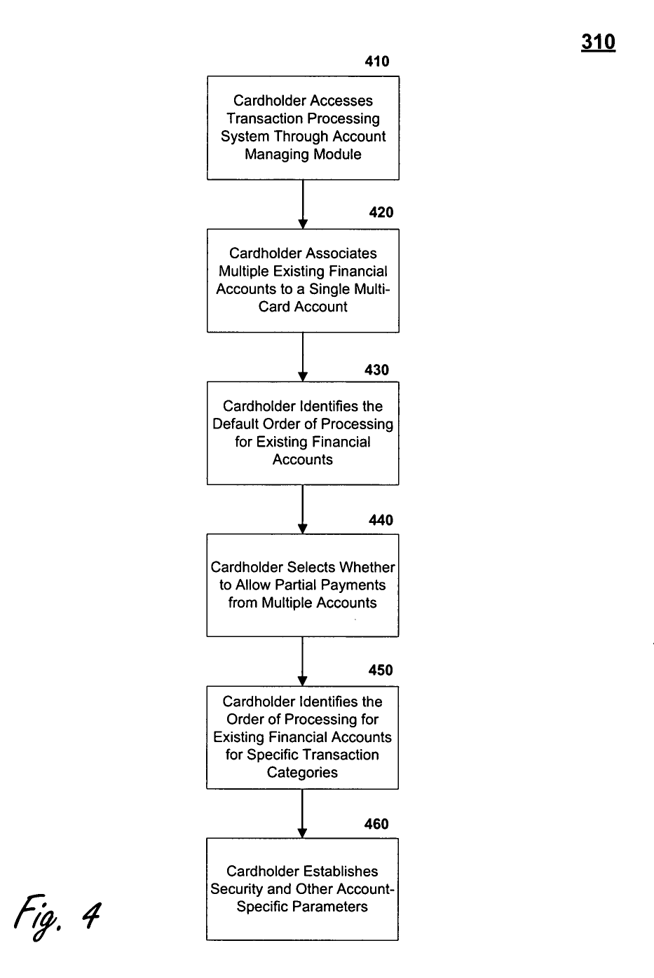

FIG. 3 depicts an overall process flow 300 in accordance with an exemplary embodiment of the present invention. Referring to FIGS. 1, 2 and 3, at step 310, a cardholder associates multiple financial accounts with a multi-card account and establishes account preferences. This step would be conducted prior to a cardholder making a financial transaction with the multi-card account. This step is discussed in greater detail below, in connection with FIG. 4.

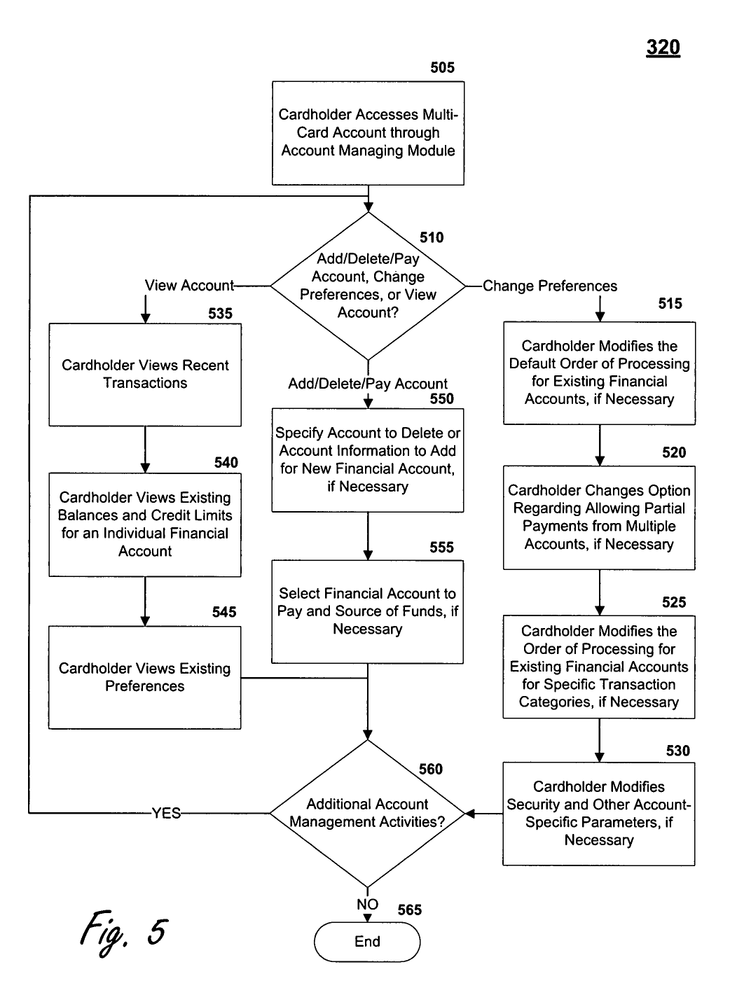

At step 320, the cardholder manages the multi-card account. This step is discussed in greater detail below, in connection with FIG. 5. One of ordinary skill in the art would appreciate that this step would be a continual step throughout the lifetime of the multi-card account. At step 330, the transaction processing system 210 receives an authorization request from a merchant, such as merchant 260. This authorization request would be made in response to a cardholder purchasing goods or services from the merchant 260. As a part of this step, the transaction processing system 210 may receive a PIN number, supplied by the cardholder making the purchase and encrypted by the merchant POS 120. This PIN would be used as a security feature, such that the transaction could be declined if the PIN was not valid.

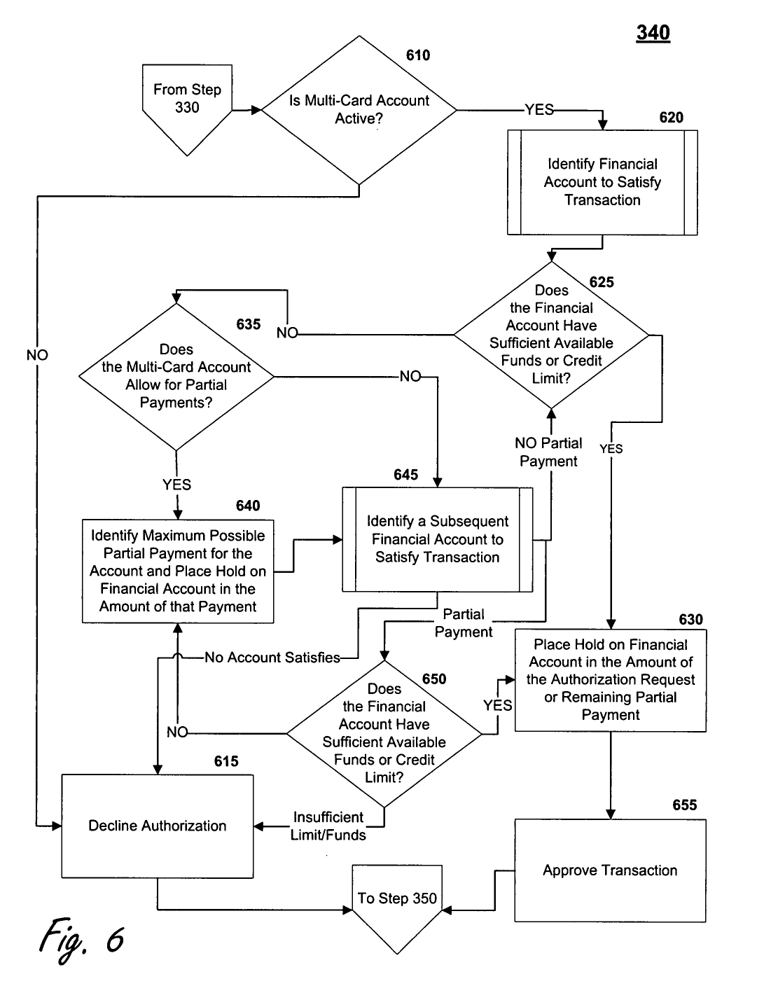

At step 340, the transaction processing system 210 processes the authorization request based on preferences established for the multi-card account. This step is discussed in greater detail below, in connection with FIG. 6. At step 350, the transaction processing system 210 returns an authorization result to the merchant 260. Typically, this result would either be an approval or rejection (decline) of the transaction.

FIG. 4 depicts a process flow 310 for associating existing financial accounts with a multi-card account in accordance with an exemplary embodiment of the present invention. Referring to FIGS. 1, 2, and 4, at step 410, a cardholder accesses the transaction processing system 210 through the account managing module 220. The cardholder may access the transaction processing system 210 using the computer 150, the PDA 152, the mobile phone 154, the land-line telephone 156, or other similar communication devices.

At step 420, the cardholder associates existing financial accounts to a single Multi-Card account. For example, the cardholder may hold a VISA card issued by BANK OF AMERICA, a PLATINUM CARD issued by AMERICAN EXPRESS, and a DISCOVER CARD issued by DISCOVER BANK. The cardholder may also have a checking account accessible by a debit card or ATM card. These financial accounts would be associated with a single multi-card account. One of ordinary skill in the art would appreciate that other financial accounts could be associated with a multi-card account, such as a money market or other savings account or a home equity line of credit account.

At step 430, the cardholder identifies a default order of processing, or ranking, for the associated accounts. For example, the cardholder may indicate that she wants transactions to be processed with the VISA account first, followed by the DISCOVER CARD, then the AMERICAN EXPRESS PLATINUM CARD, and finally the checking account. In this example, the VISA account would have the highest ranking, with the DISCOVER CARD having the next highest ranking, and so on. The cardholder is free to set the ranking. The cardholder may choose the rankings based on lowest-to-highest interest rate or based on rewards, such as frequent flier miles. Alternatively, the transaction processing system 210 may automatically set a default ranking, such as according to interest rates. So, when the cardholder makes a purchase of a $1000 television, the transaction processing module 240 of the transaction processing system 210, upon receiving an authorization request from a merchant for the $1000 purchase, would determine if the VISA account had an available credit of $1000. If not, the transaction processing module 240 would move to the next account, the DISCOVER CARD, and so on. This processing is discussed in greater detail below, in connection with FIG. 6.

In yet another alternative embodiment, the cardholder may set different rankings of financial accounts based on the dollar value of a transaction. For example, for a transaction less than $100, the cardholder may rank her checking account first, followed by the VISA account, the DISCOVER CARD, then the AMERICAN EXPRESS PLATINUM CARD. For a transaction between $100 and $1000, the cardholder may specify a ranking of the VISA account first, followed by the DISCOVER CARD, then the AMERICAN EXPRESS PLATINUM CARD, and finally the checking account. For transactions greater than $1000, the cardholder may specify the same order, but that her checking account never be accessed.

At step 440, the cardholder selects whether to allow partial payments. If so, then the transaction processing module 240, during an approval process, may approve a transaction for a single purchase by allocating the purchase to two or more existing accounts associated with the multi-card account. Again, this process is discussed below in connection with FIG. 6.

At step 450, if desired, the cardholder identifies an order of processing, or ranking, for specific transaction types. Using our example from above, for travel expenses (airline, hotel, etc.), the cardholder may indicate that the AMERICAN EXPRESS PLATINUM CARD should be used first to process the transaction, then the VISA account, followed by the DISCOVER CARD, while the checking account should never be used. In this case, the database module 230 would store the specific processing order along with MCCs and MCCGs associated with the specific transaction categories.

At step 460, the cardholder establishes security and other account parameters, such as a PIN or password, a “site key,” that is, a picture that is presented to the cardholder during the log-in process to ensure that the cardholder is logging into the correct site and not a fraudulent site designed to steal account information, and other account parameters.

FIG. 5 depicts a process flow 320 for managing a multi-card account in accordance with an exemplary embodiment of the present invention. Referring to FIGS. 1, 2, and 5, at step 505, a cardholder accesses the transaction processing system 210 through the account managing module 220. At step 510, the cardholder chooses an account management task. The cardholder may make this choice through a graphical user interface shown on the computer 150 or the PDA 152 or through an interactive voice response menu using the mobile phone 154 or the land-line telephone 156.

If the cardholder selects “Change Preferences,” at step 515, the cardholder modifies the default order, or ranking, for processing a transaction, if necessary. For example, the cardholder may be about to make a certain purchase of goods or services and the cardholder wants a specific account charged, rather than the default account. The cardholder can access the transaction processing system 210 through the account managing module 220 and identify a new order for processing a financial transaction. So, a cardholder's default order may identify a VISA account as the first account to be accessed in approving a transaction. The cardholder can change the order and have her checking account be the first account accessed for a transaction. Again, the cardholder may make this change for a specific upcoming transaction that she wants to be satisfied by a specific account.

At step 520, the cardholder may change the preference for allowing partial payments, if necessary. Similarly, at steps 525 and 530, the cardholder may change the processing order for a specific transaction type or may change other account parameters, respectively. One of ordinary skill in the art would appreciate that, although steps 515 through 530 are shown in a serial sequence, a cardholder may change preferences for one, two, three, or all four types of parameters at any one time.

If the cardholder selects “View Account,” the process 320 moves to step 535 and the cardholder views recent transactions. At step 540, the cardholder views existing balances and credit limits for the individual financial accounts associated with the multi-card account, if desired. Also, at step 545, the cardholder can view existing preferences. Again, one of ordinary skill in the art would appreciate that, although steps 535 through 545 are shown in a serial sequence, a cardholder may view preferences for one, two, or all three types of parameters at any one time.

If the cardholder selects “Add/Delete/Pay Account,” at step 550, the cardholder selects an existing account to remove from the multi-card account or provides information on a new account to associate with the multi-card account. In this way, the cardholder can change the multi-card account to reflect cancellation or addition of other financial accounts. Also, if desired, the cardholder can pay the balance of existing financial accounts at step 555.

At step 560, the process 320 determines if the cardholder has other account management tasks to perform. If “YES,” the process returns to step 510. Otherwise, it ends at step 565, such as by the cardholder logging off the transaction processing system 210.

Alternatively, a cardholder could manage her account by sending messages to the system, such as an electronic mail message or a text message. For example, prior to making a purchase, the cardholder could sent a text message to the system indicating a new ranking, or order, for account processing. The use of email or text messaging may require the account managing module 220 to send a confirmation message to the cardholder verifying the changes made to the cardholder's multi-card account.

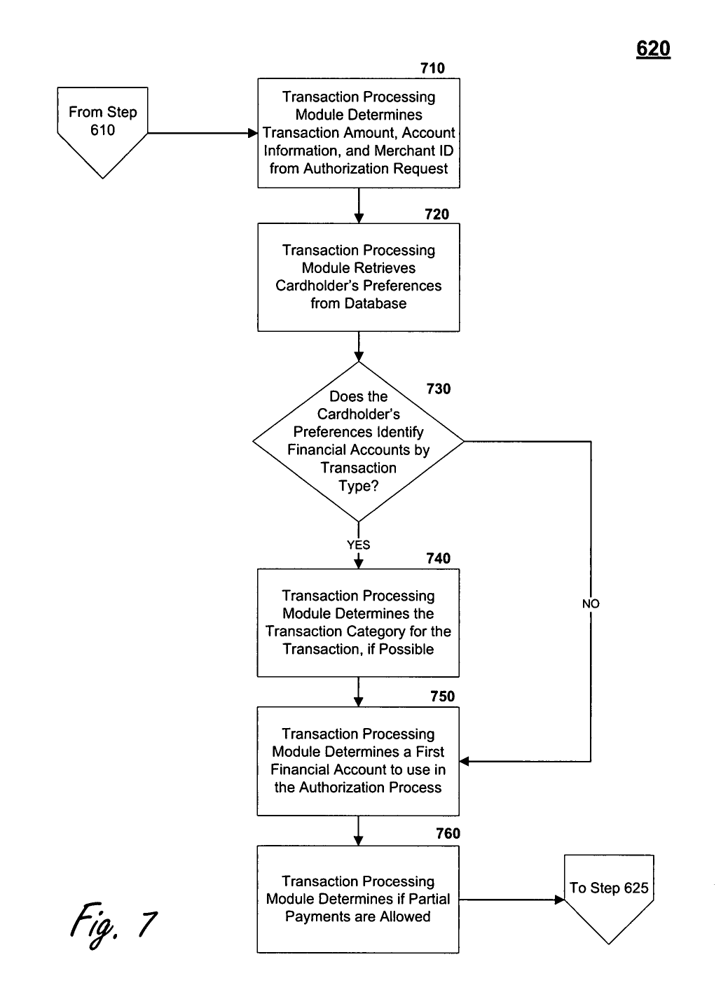

FIG. 6 depicts the process flow 340 for a transaction authorization in accordance with an exemplary embodiment of the present invention. Referring to FIGS. 1, 2, 3, and 6, at step 610, the transaction processing system 210, which received a transaction authorization request from a merchant, such as from merchant 260 using the merchant POS 120, including the terminal 125, at step 330, determines if the multi-card account is active. If “NO,” the process 340 moves to step 615 and declines the authorization request. If “YES,” the process moves to step 620, where the transaction processing module 240 identifies the financial account to satisfy the transaction. This step is described in greater detail below, in connection with FIG. 7.

At step 625, the transaction processing module 240 determines if the identified financial account has sufficient funds or credit limit. For example, if the authorization request is for the purchase of a $1200 television and the account identified at step 620 is the cardholder's VISA account, the transaction processing module 240 determines if the VISA account has an available credit limit of $1200. If “YES,” the process 340 moves to step 630 and a hold is placed on the account in the amount of the transaction ($1200 in our example above). The process 340 then moves to step 655 and approves the transaction.

If the result at step 625 is “NO,” the process moves to step 635, where the transaction processing module 240 determines if the cardholder allows partial payments for a transaction. If “NO,” the process 340 moves to step 645 and the transaction processing module 240 identifies a subsequent account to process. In this way, if the first account is “declined,” the transaction processing module 240 identifies a subsequent account that may satisfy the transaction, thus reducing the chance that an authorization request will be declined. Once a subsequent account is identified, the process 340 (no partial payment case) moves to step 625 and evaluates that subsequent account. This loop is repeated until an account that can satisfy the transaction is found or no additional accounts can be identified. If no accounts are identified that can satisfy the transaction, the process 340 moves to step 615 and declines the authorization request.

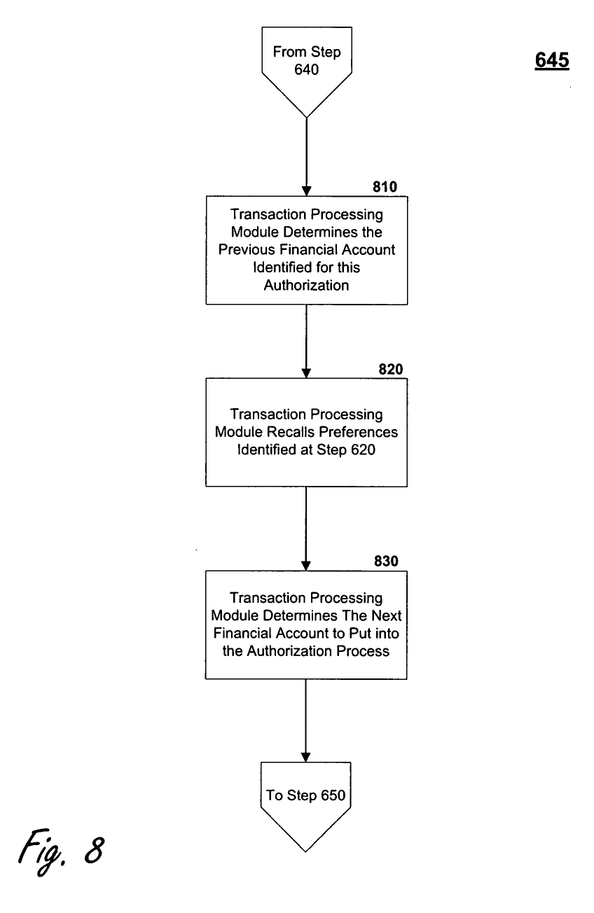

If the result at step 625 is “YES,” the process moves to step 640 and the transaction processing module 240 identifies the maximum possible partial payment for the account identified at step 620 and places a hold on that account for the amount of that payment. Continuing with our example, if the cardholder's VISA account has an available credit limit of $700, then the transaction processing module 240 puts a hold on that account for $700. The process then moves to step 645 to identify a subsequent account to satisfy the transaction. This step is described in greater detail below in connection with FIG. 8.

At step 650, the transaction processing module 240 determines if the financial account identified at step 645 has a sufficient balance or credit limit to satisfy the remaining balance of the transaction. So, continuing with the above example, the transaction processing module 240 would determine if the account identified at step 645 has a balance or credit limit of at least $500 ($1200 purchase price less the $700 allocated to the VISA account). If “YES,” the process 340 moves to step 630 and a hold is placed on the account in the amount of the remaining balance ($500 in our example above). The process 340 then moves to step 655 and approves the transaction.

If “NO,” the process 340 moves to step 640 and the transaction processing module 240 identifies the maximum possible partial payment for the account identified at step 645 and places a hold on that account for the amount of that payment. Continuing with our example, if the cardholder's DISCOVER CARD account has an available credit limit of $300, then the transaction processing module 240 puts a hold on that account for $300. A balance of $200 remains ($1200 purchase price less the $700 allocated to the VISA account and the $300 allocated to the DISCOVER CARD account). The process then moves to step 645 to identify a subsequent account to satisfy the transaction. Again, this step is described in greater detail below in connection with FIG. 8. This sequence is repeated until the entire balance is satisfied or no additional accounts can be identified. If no additional accounts can be identified to satisfy the transaction, the process 340 moves to step 615 and the transaction processing module 240 declines the authorization request and any holds placed on other financial accounts associated with the purchase would be removed.

The “partial payment” sequence described above allows a cardholder to allocate a large purchase to multiple accounts. In this way, a cardholder does not need an available account balance or credit limit on a single financial account to satisfy a purchase but instead needs an aggregate of existing balances and credit limits to satisfy the single purchase. As such, the risk that an authorization request will be declined is lowered.

One of ordinary skill in the art would appreciate that some of the authorization steps may be performed by a third party.

FIG. 7 depicts a process flow 620 for identifying an account to satisfy the authorization request in accordance with an exemplary embodiment of the present invention. Referring to FIGS. 1, 2, and 7, at step 710, the transaction processing module 240 determines a transaction amount, account information, and merchant ID from the authorization request. A point-of-sale device, such as the merchant POS 120, including the terminal 125, captures this information at the point of sale and transmits it along with the authorization request.

At step 720, the transaction processing module 240 retrieves the cardholder's preferences from the database module 230. This step uses the account information determined at step 710 to identify the cardholder. At step 730, the transaction processing module 240 determines if the cardholder has established a processing order for accounts based on different transaction types. If “YES,” the process 620 moves to step 740 and the transaction processing module 240 determines the transaction category for the transaction, if possible. This step includes accessing the database module 230 or other data source, such as a data source at the third-party vendor 270 or the card association/financial institution 280, to determine an MCC or MCCG for the merchant, based on the identified merchant ID. In some cases, the category of the transaction may not be determined, such as when information on a specific merchant is not stored in an available data store.

If the result at step 730 is “NO” or after step 740, the transaction processing module 240, at step 750, determines the first financial account to use in the authorization process. This first account (or highest ranked account) will be specific by the cardholder in preferences. At step 760, the transaction processing module 240 also determines if the cardholder allows for partial payments.

FIG. 8 depicts a process flow 645 for identifying a subsequent account to satisfy the authorization request in accordance with an exemplary embodiment of the present invention. Referring to FIGS. 1, 2, 6, and 8, at step 810, the transaction processing module 240 determines the previous financial account identified during the authorization process, either at step 620 or step 645. In other words, the transaction processing module 240 determines which account or accounts on a preference list have already been evaluated.

At step 820, the transaction processing module 240 recalls preferences identified at step 620, that is, the entire ranking, or order for processing transactions, and whether partial payments are allowed. At step 830, the transaction processing module 240 determines the next financial account to evaluate in the authorization process. This account would be the financial account with the next highest rank as compared to the accounts previously evaluated.

One of ordinary skill in the art would appreciate that the present invention provides systems and methods for associating multiple financial accounts with a single multi-card account. The single multi-card account may allow a cardholder to determine an order for processing a financial transaction among the multiple financial accounts. This ordering may be dependent on the type of financial transaction. Also, the cardholder may allows partial payments from multiple financial accounts, such that a single purchase could be allocated to multiple accounts associated with the multi-card account. These systems and methods minimize the number of cards a cardholder must carry, thus minimizing the chance of losing cards or otherwise having an unauthorized use of an account and also minimizing the chance of an embarrassing rejection of a transaction.

1. A method for processing a financial transaction comprising the steps of: associating a multi-card account with a plurality of existing financial accounts;
receiving from the multi-card account cardholder a ranking for the existing financial accounts, wherein the ranking comprises the preferred order for which the existing financial accounts should be accessed to fund the financial transaction;
receiving an authorization request for the financial transaction for the multi-card account comprising an amount of money representing the outstanding balance for the financial transaction; and
determining the existing financial account to pay the outstanding balance for the financial transaction based on the received ranking.

2. The method of claim 1 wherein the step of determining the existing financial account to pay the outstanding balance for the financial transaction based on the received ranking further comprises the steps of:
a) selecting a first existing financial account comprising the highest ranked existing financial account;
b) determining if the selected existing financial account contains available funds or available credit limit equal to or greater than the outstanding balance for the financial transaction;
c) approving the authorization request for the financial transaction if the selected existing financial account contains available funds or available credit limit equal to or greater than the outstanding balance for the financial transaction;
d) otherwise selecting the next highest ranked existing financial account and repeating steps b) through d).

3. The method of claim 2 further comprising the step of declining the authorization request if no ranked existing financial account satisfies step c).

4. The method of claim 1 wherein the step of receiving from the multi-card account cardholder a ranking for the existing financial accounts further comprising an indication that the multi-card account comprises partial payments.

5. The method of claim 4 wherein the step of determining the existing financial account to fund the financial transaction based on the received ranking further comprises the steps of:
a) selecting a first existing financial account comprising the highest ranked existing financial account;
b) determining the amount of available funds or available credit limit associated with the selected existing financial account;
c) charging the selected existing account an amount of money comprising the lesser of the amount of available funds or available credit limit for the selected existing account and the outstanding balance for the financial transaction;
d) calculating the difference between outstanding balance for the financial transaction and the amount of money charged the selected account at step c), wherein this difference comprises the updated outstanding balance for the financial transaction;
e) if the updated outstanding balance is greater than zero, selecting the next highest ranked existing financial account; p1 f) repeating steps b) through e) as necessary until the updated outstanding balance for the financial transaction equals zero; and
g) approving the authorization request.

6. The method of claim 5 further comprising the step of declining the authorization request if the updated outstanding balance fails to reach zero after selecting all ranked existing financial accounts.

7. The method of claim 1 wherein the step of determining the existing financial account to pay the outstanding balance for the financial transaction based on the received ranking comprises the steps of:
determining a category for the financial transaction; and
identifying the existing financial account to pay the outstanding balance based on the category for the financial transaction.

8. The method of claim 7 wherein the category comprises a merchant category code.

9. A method for processing a financial transaction comprising the steps of:
a) receiving an authorization request for the financial transaction for the multi-card account comprising an amount of money representing the outstanding balance for the financial transaction, wherein the multi-card account comprises a plurality of existing financial accounts;
b) determining a existing financial account to pay the outstanding balance for the financial transaction based on a ranking, wherein the ranking comprises the preferred order for which the existing financial accounts should be accessed to fund the financial transaction;
c) selecting a first existing financial account comprising the highest ranked existing financial account;
d) determining the amount of available funds or available credit limit associated with the selected existing financial account;
e) charging the selected existing account an amount of money comprising the lesser of the amount of available funds or available credit limit for the selected existing account and the outstanding balance for the financial transaction;
f) calculating the difference between outstanding balance for the financial transaction and the amount of money charged the selected account at step c), wherein this difference comprises the updated outstanding balance for the financial transaction;
g) if the updated outstanding balance is greater than zero, selecting the next highest ranked existing financial account;
h) repeating steps d) through g) as necessary until the updated outstanding balance for the financial transaction equals zero; and
i) approving the authorization request.

10. The method of claim 9 further comprising the step of receiving the ranking of existing financial accounts from a cardholder for the multi-card account.

11. The method of claim 9 wherein the selection of financial accounts comprise selecting the account based on a category for the financial transaction.

12. The method of claim 11 wherein the category comprises a merchant category code.

13. A system for processing a financial transaction comprising:
a managing module, operable to receive a ranking of a plurality of existing financial accounts comprising a multi-card account, wherein the ranking comprises the preferred order for which the existing financial accounts should be accessed to fund the financial transaction; and
a transaction processing module, operable to process an authorization request for a financial transaction associated with a multi-card account, wherein the processing is based on the ranking of the plurality of existing financial accounts.

14. The system of claim 13 further comprising a database module, logically connected to the managing module and the transaction processing module and operable to store the ranking of the plurality of existing financial accounts and further operable to respond to requests from the transaction processing module to determine the stored ranking.

15. The system of claim 13 wherein the transaction processing module is logically connected to one or more third-parties comprising transaction processing parties.

16. A multi-card for purchasing goods or services comprising a plurality of existing financial accounts wherein the plurality of financial accounts comprise a ranking indicating the preferred order for which the existing financial accounts should be accessed to fund the financial transaction.

17. The apparatus of claim 16 further comprising an allocation of a single purchase to two or more of the financial accounts.

18. The apparatus of claim 16 wherein a cardholder of the multi-card specifies the ranking.

19. The apparatus of claim 18 wherein the ranking comprises different rankings for different categories of goods or services.

20. The apparatus of claim 19 wherein each category comprises a merchant category code.
